(19) United States
(12) Patent Application Publication
(10) Pub. No.: US 2026/0279181 A1
(43) Pub. Date: Sep. 17, 2026

(54) SYSTEM FOR NOTIFYING A USER OF AN EXISTENCE OF A PASSENGER

(71) Applicant: Monica Rose VIGIL, Poway, CA (US)

(72) Inventor: Monica Rose VIGIL, Poway, CA (US)

(21) Appl. No.: 19/081,278

(22) Filed: Mar. 17, 2025

(51) Int. Cl. G08B 21/02; B60Q 9/00

(52) U.S. Cl. CPC G08B 21/02; B60Q 9/00

(57) ABSTRACT

Disclosed herein are system, method, and computer program product embodiments for notifying a user of an existence of a passenger remaining in a vehicle. An embodiment operates by receiving passenger profile data and destination data of the passenger. The embodiment then associates the passenger profile data with a seat position of the vehicle. The embodiment then tracks a location of the vehicle. In response to the vehicle stopping at a destination, the embodiment then generates a match signal whether or not the destination matches the destination data. In response to the match signal indicating a match, the embodiment then notifies the user whether or not the passenger has exited the seat position.

### BACKGROUND

The unintentional act of leaving children inside vehicles can pose a significant threat, especially in hot climates where it can cause Pediatric Vehicular Heatstroke (PVH), a severe heat-related injury that can result in fatal consequences. Despite the progress made in driving technology, current solutions have not been effective in addressing this problem.

In addition to the PVH, leaving passengers in need of assistance on the vehicle poses a serious health risk to the passengers.

Many driving applications provide a range of useful features such as route optimization, scheduling, and passive notifications related to the driving experience. However, they do not include specific functionalities to remind drivers of the presence of passengers in the vehicle. The automatic reminders that are available can often be ignored, failing to capture the driver's attention or require their active engagement.

There is a significant need for a reminder system that actively engages the driver so as to prevent tragic outcomes.

### BRIEF DESCRIPTION OF THE DRAWINGS

The accompanying drawings are incorporated herein and form a part of the specification.

FIG. 1 is a block diagram of a system for notifying a user of an existence of a passenger, according to some embodiments.

FIG. 2 is a flowchart for a method for notifying the user of the existence of the passenger, according to some embodiments.

FIG. 3 is a sub-flowchart for an operation for receiving the passenger profile data and destination data, according to some embodiments.

FIG. 4 is a user interface for receiving the passenger profile data, according to some embodiments.

FIG. 5 is a sub-flowchart for an operation for associating the passenger profile data with a seat position, according to some embodiments.

FIG. 6 is a user interface for associating the passenger profile data with the seat position, according to some embodiments.

FIG. 7 is a sub-flowchart for an operation for tracking a location of a vehicle and notifying the user whether or not the passenger has exited the seat position, according to some embodiments.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for performing notifying a user of an existence of a passenger.

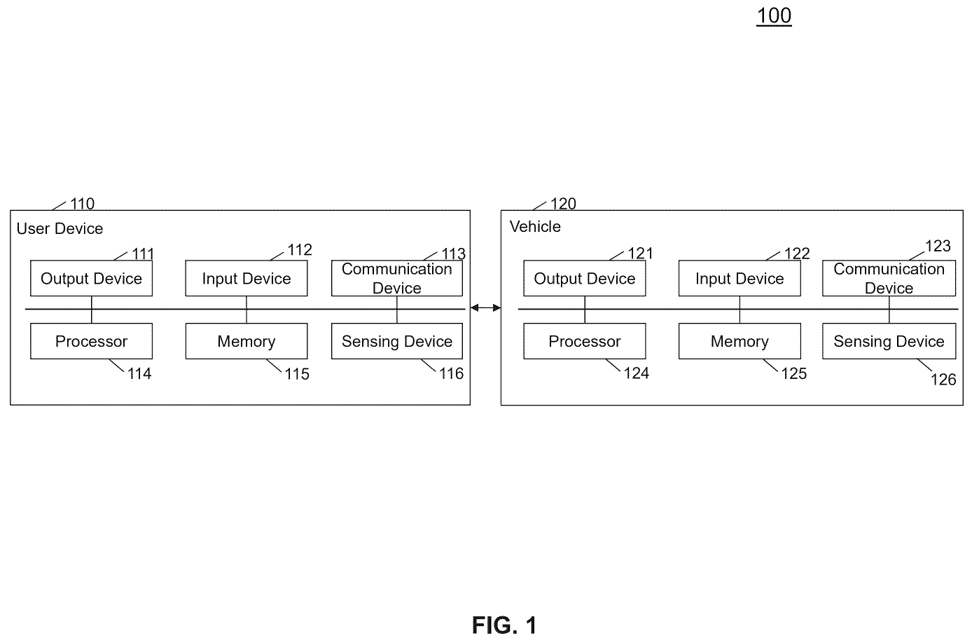

FIG. 1 is a block diagram of a system 100, according to some embodiments. For example, the system 100 may be for notifying a user of an existence of a passenger in a vehicle. The system 100 may include a user device 110 and a vehicle 120. The user device 110 and the vehicle 120 may be configured as separate devices as shown in FIG. 1. However, some or all of the hardware or functions of the user device 110 may be incorporated into the vehicle 120. Similarly, some or all of the hardware or functions of the vehicle 120 may be incorporated into the user device 110. In other words, the system 100 may not be limited to the configuration shown in FIG. 1, and the system 100 may be configured using, for example, the user device 110 or the vehicle 120 alone.

The user device 110 may be a device of a driver of the vehicle 120. The driver may be the user of the system 100. The user device 110 may move with the vehicle 120. The user device 110 may be an electronic device such as a smartphone or a tablet. The user device 110 may include an output device 111, an input device 112, a communication device 113, a processor 114, a memory 115, and a sensing device 116. The components of the user device 110 may be able to communicate with each other via a bus.

The output device 111 may be a liquid crystal display (LCD) or an organic light emitting diode (OLED) display of the user device 110. The output device 111 may display a user interface to notify the user of information. The output device 111 may further include a speaker or other devices to output a notification to the user.

The input device 112 may be a virtual/physical keyboard, a touch screen, a camera, a microphone, etc., or a combination thereof. The input device 112 may receive an input from the user.

The communication device 113 may be a short-range communication module, an internet/cellular communication module, or a combination thereof. The communication device 113 may communicate with the vehicle 120 or other remote devices.

The processor 114 may be a dedicated or general-purpose central processing unit (CPU), graphic processing unit (GPU), or a combination thereof. The processor 114 may be coupled to the memory 115. The processor 114 may be configured to perform operations for the user device 110.

The memory 115 may be a long-term or short-term storage device or a combination thereof. The memory 115 may store instructions or data to be processed by the processor 114.

The sensing device 116 may be an image sensor, a sound sensor, a temperature sensor, an infrared radiation (IR) sensor, a fingerprint sensor, a position sensor, a magnetic sensor, etc., or a combination thereof. The sensing device 116 may provide sensing data necessary for the operation of the user device 110.

The vehicle 120 may be a car, a bus, a train, a ship, a plane, etc. The vehicle 120 may include an output device 121, an input device 122, a communication device 123, a processor 124, a memory 125, and a sensing device 126. The components of the vehicle 120 may be able to communicate with each other via a bus.

The output device 121 may be an LCD or an OLED display of the vehicle 120. The output device 121 may display a user interface to notify the user of information. The output device 121 may further include a speaker or other device to output a notification to the user.

The input device 122 may be a virtual/physical keyboard, a touch screen, a camera, a microphone, etc., or a combination thereof. The input device 122 may receive an input from the user.

The communication device 123 may be a short-range communication module, an internet/cellular communication module, or a combination thereof. The communication device 123 may communicate with the vehicle 120 or other remote devices.

The processor 124 may be a dedicated or general-purpose CPU, GPU, or a combination thereof. The processor 124 may be coupled to the memory 125. The processor 124 may be configured to perform operations for the vehicle 120.

The memory 125 may be a long-term or short-term storage device or a combination thereof. The memory 125 may store instructions or data to be processed by the processor 124.

The sensing device 126 may be an image sensor, a sound sensor, a temperature sensor, an IR sensor, a fingerprint sensor, a position sensor, a magnetic sensor, a speed sensor, an acceleration sensor, a door sensor, a weight sensor for seats, a light detection and ranging (LiDAR) sensor, etc., or a combination thereof. The sensing device 126 may provide sensing data necessary for the operation of the vehicle 120.

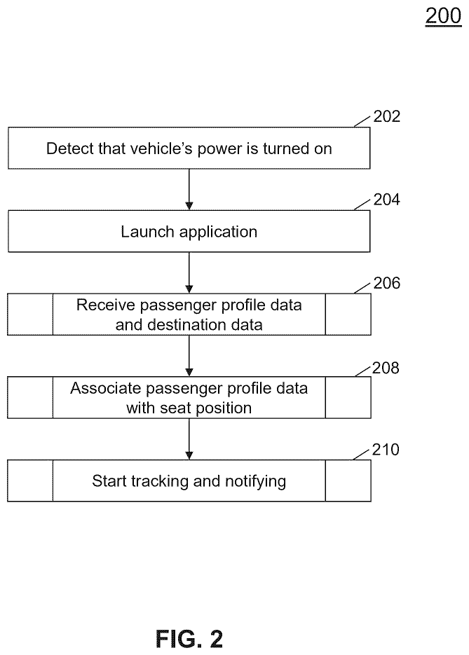

FIG. 2 is a flowchart for a method 200, according to some embodiments. For example, the method may be for notifying the user of the existence of the passenger. The method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously or in a different order than shown in FIG. 2, as will be understood by a person of ordinary skill in the art.

In 202, the system 100 may detect that power of the vehicle 120 is turned on. For example, the system 100 may detect that the power of the vehicle 120 is turned on in response to the insertion or rotation of the ignition key or the pressing of the power button. The fact that the power of the vehicle 120 is turned on may be detected by the processor 124. The processor 114 may also detect that the power of the vehicle 120 has been turned on by receiving a start signal from the processor 124 via the communication devices 113 and 123. In other words, the start signal represents that the vehicle 120 is turned on. The processor 124 may detect that the power of the vehicle 120 has been turned on and transmit the start signal to the processor 114 via the communication devices 113 and 123.

In 204, the system 100 may launch an application. The memory 115 and/or memory 125 may store the applications. In other words, the application may be executed by either the user device 110 or the vehicle 120. The application may perform the following processing for the method 200.

In 206, the system 100 may receive passenger profile data and destination data. The passenger profile data may include a profile of the passenger. The destination data may include a destination of the passenger. Details of the operation 206 are described below.

In 208, the system 100 may associate the passenger data with a seat position. The seat position may correspond to the actual seat position of the vehicle 120. In this way, the application can recognize which passengers are sitting in which positions of the vehicle 120. Details of the operation 208 are described below.

In 210, the system 100 may start tracking a location of the vehicle 120 and notifying the user of the existence of the exiting passenger based on the tracked location and the destination of the passenger. The sensing device 116 and/or the sensing device 126 may track the location of the vehicle. The output device 111 and or the output device 121 may output the notification. The notification may include notifying the user whether or not the passenger has exited the seat position. Details of the operation 208 are described below.

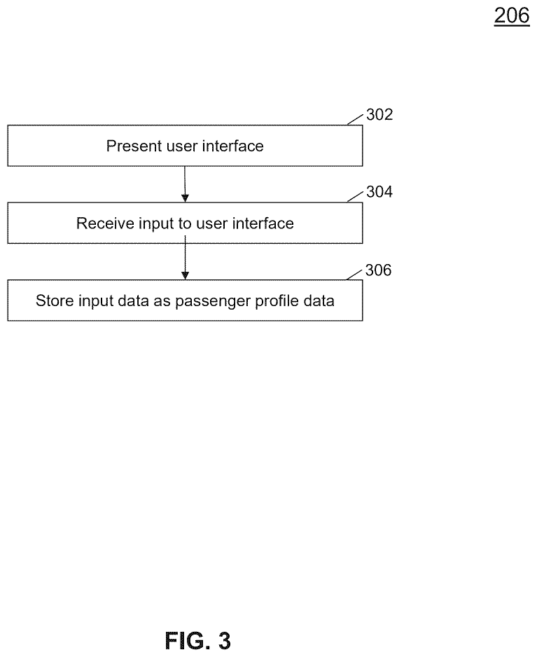

FIG. 3 is a sub-flowchart for the operation 206, according to some embodiments. For example, operation 206 may be for receiving the passenger profile data and destination data. The passenger profile data may be received before the vehicle 120 departs. The destination data may be received each time before the vehicle 120 departs.

In 302, the system 100 may present the user interface to the user or the passenger. The user interface may be displayed on the output device 111 or the output device 121 of the user device 110 or the vehicle 120. An example of the user interface is given below.

In 304, the system 100 may receive input to the user interface. For example, the user may input items of the passenger profile and the destination data of the passenger. In another example, the passenger may input items of the passenger profile and the destination data of the passenger. The input to the user interface may be carried out by using a touch input, voice input, image input, etc.

In 306, the system 100 may store the input data as the passenger profile data and destination data. The passenger profile data and destination data may be stored in the memory 115 or the memory 125.

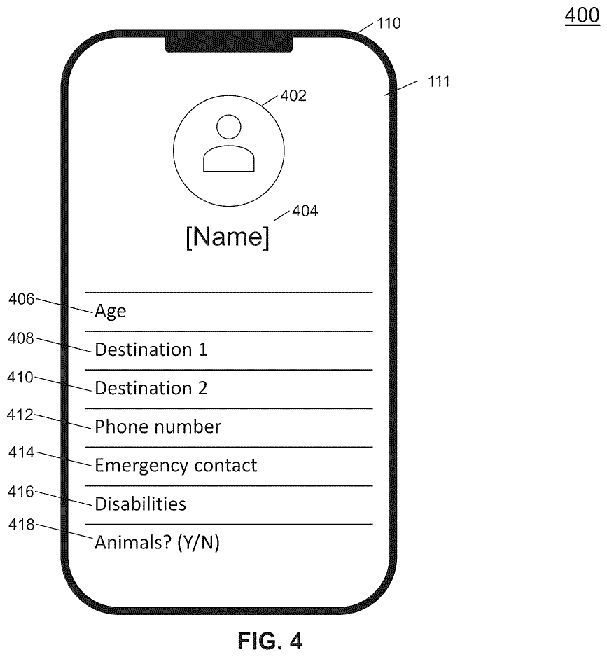

FIG. 4 is the user interface 400, according to some embodiments. For example, the user interface 400 may be for receiving the passenger profile data. As shown in FIG. 4, the user interface 400 may be displayed on the output device 111 of the user device 110. In another example, the user interface 400 may be displayed on the output device 121 of the vehicle 120.

The user interface 400 may include a passenger image field 402, a name field 404, an age field 406, destination fields 408 and 410, a phone number field 412, an emergency contact field 414, a disability field 416, and an animal indication field 418.

The passenger image field 402 may store a photo of the passenger. By referring the photo, the user can confirm that the passenger is indeed the person registered in the passenger profile data. The photo of the passenger may be used for associating the passenger profile data with the seat position.

The name field 404 may indicate a name of the passenger. The name of the passenger may be used in the notification. The details of the notification are described below.

The age field 406 may indicate an age of the passenger. The age may be used for determining whether the system 100 operates the notification. The details of the notification are described below.

The destination fields 408 and 410 may indicate destination(s) of the passenger. The destination can be entered each time before the vehicle 120 departs. The destination(s) may be stored as the destination data. The destination data may be used for the notification. The details of the notification are described below.

The phone number field 412 may indicate a phone number of the passenger. The phone number may be the passenger's own. The phone number may be that of a remote device owned by the passenger's guardian, and the phone number may be used for alerting. The details of the alerting are described below.

The emergency contact field 414 may indicate an emergency phone number or any other means of contact. The emergency contact information may be used for alerting. The details of the alerting are described below.

The disability field 416 may indicate a type of disability the passenger has. The type of disability may be used for determining whether the system 100 operates the notification. The details of the notification are described below.

The animal indication field 418 indicates whether the passenger is an animal. The indication may be used for determining whether the system 100 operates the notification. The details of the notification are described below.

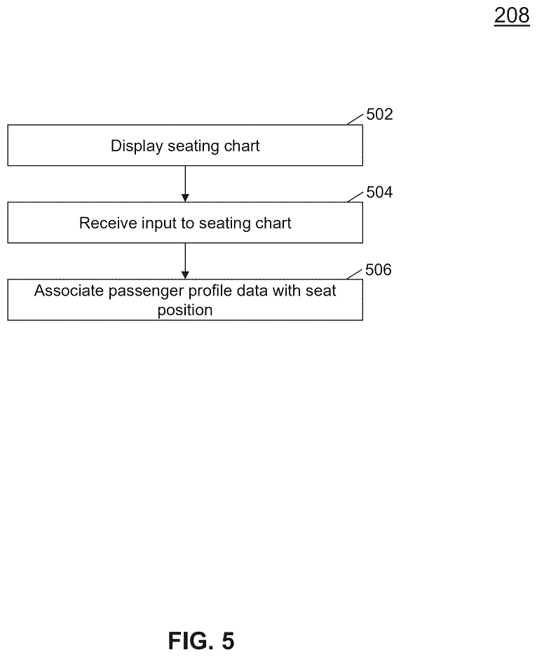

FIG. 5 is a sub-flowchart for the operation 208, according to some embodiments. For example, the operation 208 may be for associating the passenger profile data with the seat position.

In 502, the system 100 may display a seating chart. The output device 111 or the output device 121 may display the seating chart to the user and/or the passenger.

In 504, the system 100 may receive input to the seating chart. The user or the passenger may input seat information that identifies who is sitting in which seat using the input device 112 or the input device 122. For example, the user or the passenger may use a touchpad to input the seat information. In another example, the user or the passenger may use a microphone to input the seat information. In yet another example, the sensing device 116 or the sensing device 126 may input the seat information. For example, a camera of the user device 110 or the vehicle 120 may detect a face image of the passenger. Then, a camera of the user device 110 or the vehicle 120 and/or a weight sensor of the vehicle 120 may detect a position of the passenger. And by matching the detected image data with the passenger profile data, the processor 114 or the processor 124 may input the seat information based on the face image and the detected position of the passenger.

In 506, the system 100 may associate the passenger profile data with the seat position. As such, the system 100 can recognize which passengers are sitting on which seats.

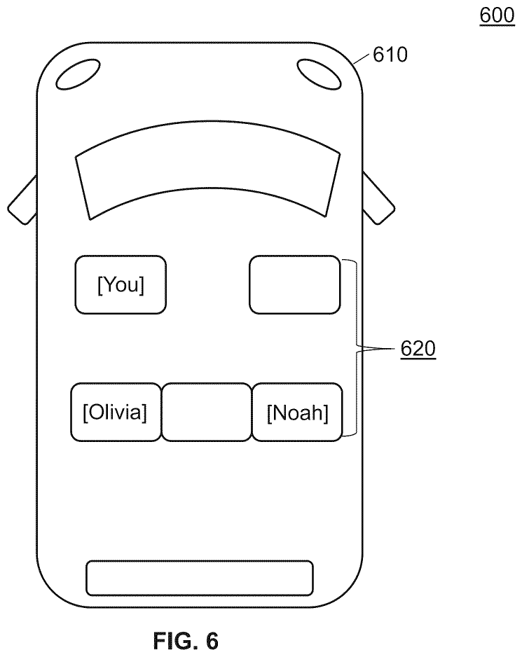

FIG. 6 is a user interface 600, according to some embodiments. For example, the user interface 600 may be for associating the passenger profile data with the seat position. As shown in FIG. 6, the user interface 600 may include a schematic diagram 610 of the vehicle 120. The schematic diagram 610 may include the seating chart 620 corresponding to the actual seat arrangement of the vehicle 120. The user or the passenger can input the seat information to the user interface 600 in the manner described above. For example, as shown in FIG. 6, the seating chart 620 shows Olivia in the left rear seat and Noah in the right rear seat.

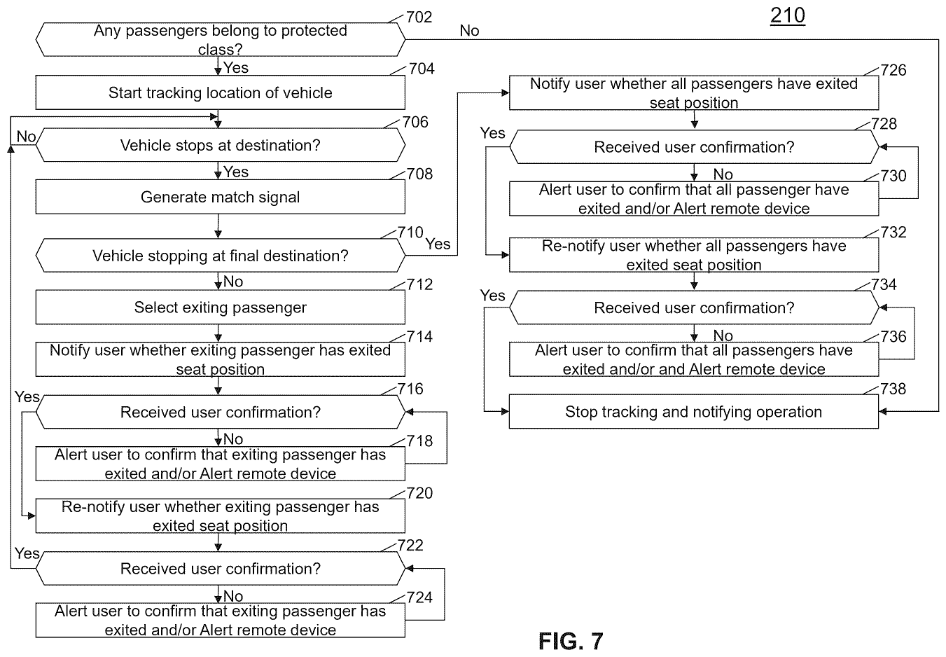

FIG. 7 is a sub-flowchart for the operation 208, according to some embodiments. For example, the operation 208 may be for tracking the location of the vehicle 120 and notifying the user whether or not the passenger has exited the seat position.

In 702, the system 100 may determine whether any passengers belong to a protected class. The protected class may be a class of passengers who would have difficulty escaping on their own if they were left behind in the vehicle 120.

For example, minors, kids, or infants may belong to the protected class. Older people may also belong to the protected class. When determining whether the passenger belongs to the protected class based on their age, the system 100 may compare the age recorded in the passenger profile data with a predetermined threshold value.

In another example, people with certain disabilities may also belong to the protected class. When determining whether the passenger belongs to the protected class based on their disabilities, the system 100 may make a decision based on the type of disabilities indicated in the passenger profile data.

Yet in another example, if the passenger is an animal such as a pet, the passenger may belong to the protected class. When determining whether the passenger belongs to the protected class based on whether they are animals, the system 100 may make a decision based on the animal indication field 418 of the passenger profile data.

In 704, if the system 100 determines that at least one of the passengers belongs to the protected class, the system 100 may start tracking the location of the vehicle 120. For example, the sensing device 116 or the sensing device 126 may track the location of the vehicle 120.

In 706, the system 100 may determine whether the vehicle 120 has stopped at the destination. For example, the system 100 may use the tracked location of the vehicle and the destination indicated in the destination data to determine whether the vehicle 120 has stopped at the destination. The system 100 may also ask the user to determine whether the vehicle 120 has stopped at the destination. The system 100 may also determine that the vehicle 120 has stopped at the destination in response to the vehicle 120 remaining in the same location for more than a certain period of time, or an engine/motor of the vehicle 120 has stopped. If the system 100 determines that the vehicle 120 has not stopped at the destination, the operation may loopback to the operation 706.

In 708, if the system 100 determines that the vehicle 120 has stopped at the destination in 706, the system 100 may generate a match signal. For example, the processor 114 or the processor 124 may generate the match signal.

In 710, in response to the match signal, the system 100 may determine whether the stopped destination is a final destination or not (e.g., the destination is the final destination or a temporary destination). For example, the system 100 may inquire the user whether the stopped destination is the final destination or not. The system 100 may also determine whether the stopped destination is the final destination or not autonomously. For example, system 100 may determine whether the stopped destination is the final destination or not based on the destination data of the passengers. In other words, if there are still unreached destinations in the destination data of the passengers, the system 100 may determine that the vehicle 120 is stopped at the temporary destination, otherwise the system 100 may determine that the vehicle 120 is stopped at the final destination.

In 712, if the system 100 determines that the stopped destination is not a final destination in 710, the system 100 may select an exiting passenger. For example, the system 100 may select the exiting passenger based on the destination data. In other words, the system 100 may select the passenger as the exiting passenger if the passenger's destination data matches or is close to the stopped location.

In 714, the system 100 may notify the user whether the exiting passenger has exited the seat position. For example, the output device 111 or the output device 121 may display the schematic diagram 610 of the vehicle 120 with the seats occupied by the exiting passenger highlighted. The output device 111 or the output device 121 may also notify the user by an audio message or a text message (i.e., “Please drop off Olivia, who is sitting in the back on the left, here.”).

In 716, the system 100 may determine whether the system 100 received the user confirmation, which confirms that the exiting passenger has exited their seat position, within a predetermined time period. The user may input the confirmation via the input device 112 or the input device 122. Yet in another example, the system 100 may use the sensing device 116 or the sensing device 126 to automatically detect whether the passenger has exited from their seat position.

In 718, if the system 100 determines that the system 100 did not receive the user confirmation within the predetermined time period in 716, the system 100 may alert the user to confirm that the exiting passenger has exited. For example, the system 100 may use the output device 111 or the output device 121 to alert the user with sound or a user interface. As the user interface, the output device 111 or the output device 121 may display the schematic diagram 610 of the vehicle 120 with the seats occupied by the exiting passenger highlighted.

In 718, the system 100 may also alert the remote device of the exiting passenger. For example, the communication device 113 or the communication device 123 may transmit a text message, an email, or a phone call to the emergency contact or the authorities or the phone number of the exiting passenger by referring to the passenger profile data. The remote device can be alerted at a specified time after the user is alerted, at the same time as the user is alerted, or independent of the alert. After the operation 718, the system 100 may determine whether the system 100 received the user confirmation in 716 again.

In 720, if the system 100 determines that the system 100 received the user confirmation within the predetermined time period in 716, the system 100 may re-notify the user whether the exiting passenger has exited the seat position. For example, the output device 111 or the output device 121 may again display the schematic diagram 610 of the vehicle 120 with the seats occupied by the exiting passenger highlighted. The output device 111 or the output device 121 may also notify the user by an audio message or a text message (i.e., “Are you sure that Olivia in the left rear seat got out of the car?”).

In 722, the system 100 may determine whether the system 100 received the user re-confirmation, which re-confirms that the exiting passenger has exited their seat position within a predetermined time period. The user may input the re-confirmation via the input device 112 or the input device 122. Yet in another example, the system 100 may use the sensing device 116 or the sensing device 126 to automatically detect whether the passenger has exited from their seat position. In other words, in 716, confirmation may be performed by user operation, and in 722, the system 100 may automatically re-confirm. If the system 100 determines that the system 100 received the user re-confirmation, the operation may loopback to the operation 706.

In 724, if the system 100 determines that the system 100 did not receive the user re-confirmation within the predetermined time period in 722, the system 100 may alert the user to confirm that the exiting passenger has exited in the same way as in 718. The system 100 may also alert the remote device of the exiting passenger in the same way as in 718. After the operation 724, the system 100 may determine whether the system 100 received the user re-confirmation in 722 again.

In 726, if the system 100 determines that the stopped destination is the final destination in 710, the system 100 may notify the user whether all the passengers have exited the seat positions. For example, the output device 111 or the output device 121 may display the schematic diagram 610 of the vehicle 120 with the seats occupied by all passengers highlighted. The output device 111 or the output device 121 may also notify the user by an audio message or a text message (i.e., “Please drop off Olivia, who is sitting in the back on the left, and Noah, who is sitting in the back here.”).

In 728, the system 100 may determine whether the system 100 received the user confirmation, which confirms that all passengers have exited their seat positions, within a predetermined time period in the same way as in 716.

In 730, if the system 100 determines that the system 100 did not receive the user confirmation in 728, the system may alert the user to confirm that all passengers have exited in the same way as in 718. The system 100 may also alert the remote device of the exiting passenger in the same way as in 718. After the operation 730, the system 100 may determine whether the system 100 received the user confirmation in 728 again.

In 732, if the system 100 determines that the system 100 received the user confirmation within the predetermined time period in 728, the system 100 may re-notify the user whether the all passengers have exited the seat position. For example, the output device 111 or the output device 121 may again display the schematic diagram 610 of the vehicle 120 with the seats occupied by all passenger highlighted. The output device 111 or the output device 121 may also notify the user by an audio message or a text message (i.e., “Are you sure that Olivia in the left rear seat and Noah in the right rear seat got off the car?”).

In 734, the system 100 may determine whether the system 100 received the user re-confirmation in the same way as in operation 722.

In 736, if the system 100 determines that the system 100 did not receive the user re-confirmation within the predetermined time period in 734, the system 100 may alert the user to confirm that all passengers have exited in the same way as in 718. The system 100 may also alert the remote devices of all passengers in the same way as in 718. After the operation 736, the system 100 may determine whether the system 100 received the user re-confirmation in 738 again.

In 738, if the system 100 determines that passengers belong to the protected class, or if the system 100 determines that the system 100 received the user re-confirmation within the predetermined time period in 734, the system 100 may stop the tracking and notifying operation.

According to the above disclosure, the system 100 can provide the user with a more reliable confirmation of whether or not a passenger remains in the vehicle. Thus, according to the above disclosure, the risk of passengers being left behind in the vehicle can be reduced.

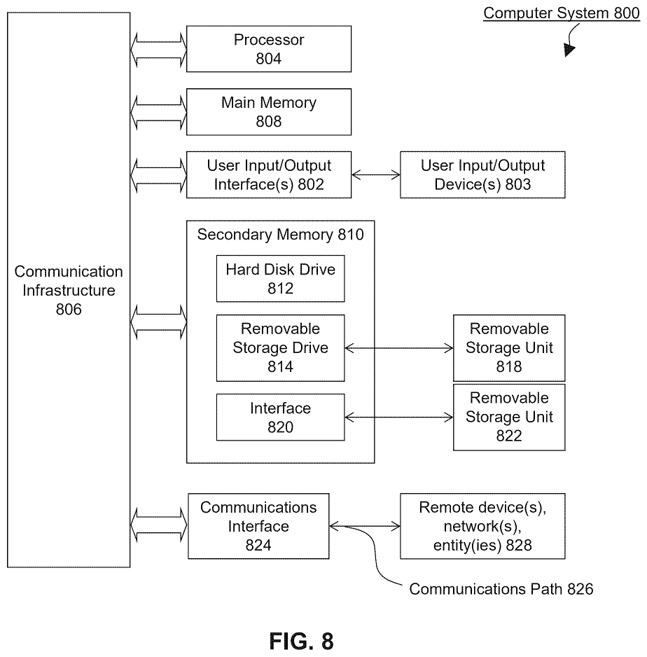

FIG. 8 is an example computer system useful for implementing various embodiments. Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). A GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system for notifying a user of an existence of a passenger remaining in a vehicle, comprising:
a memory; and
a processor coupled to the memory and configured to perform operations comprising:
receiving passenger profile data and destination data of the passenger,
associating the passenger profile data with a seat position of the vehicle,
tracking a location of the vehicle,
in response to the vehicle stopping at a destination, generating a match signal whether or not the destination matches the destination data, and
in response to the match signal indicating a match, notifying the user whether or not the passenger has exited the seat position.

2. The system of claim 1, wherein the operations further comprise:
receiving second passenger profile data and second destination data of a second passenger, wherein the operation of generating the match signal further comprises generating the match signal whether or not the destination matches at least one of the destination data and the second destination data;
associating the second passenger profile data with the second seat position of the vehicle;
in response to the match signal indicating the match, notifying the user whether or not the vehicle is at a final destination; and
in response to determining that the vehicle is at the final destination, notifying the user whether or not all the passengers have exited all the seat positions.

3. The system of claim 2, wherein the operations further comprise:
in response to determining that the vehicle is not at the final destination:
selecting an exiting passenger from the passenger and the second passenger based on a location of the vehicle, the destination data, and the second destination data;
notifying the user whether or not the exiting passenger has exited at least one of the seat position and the second seat position.

4. The system of claim 1, wherein the receiving passenger profile data and destination data of the passenger and associating the passenger profile data with the seat position of the vehicle comprise:
displaying a seating chart of the vehicle to the user on a graphical user interface; and
associating the passenger profile data with the seat position of the vehicle based on an input for the seating chart.

5. The system of claim 1, wherein the operations further comprise:
determining that the user has not confirmed that the passenger has exited the seat position; and
alerting the user to confirm that the passenger has exited the seat position.

6. The system of claim 1, wherein:
the passenger profile data further comprises contact information of a remote device, and
the operations further comprise:
determining that the user does not confirm that the passenger has exited the seat position; and
alerting the remote device that the user has not confirmed that the passenger has exited the seat position.

7. The system of claim 1, wherein the operations further comprise:
determining that the user has confirmed that the passenger has exited the seat position; and
re-notifying the user whether or not the passenger has exited the seat position.

8. The system of claim 1, further comprising:
determining whether the passenger belongs to a protected class based on the passenger profile data,
wherein the notifying the user whether or not the passenger has exited the seat position is performed in response to determining that the passenger belongs to the protected class.

9. The system of claim 8, wherein:
the passenger profile data further comprises an age of the passenger, and
the determining whether the passenger belongs to the protected class is based on comparing the age of the passenger with a predetermined value.

10. The system of claim 8, wherein:
the passenger profile data further comprises a type of disability of the passenger, and
the determining whether the passenger belongs to the protected class is based on the type of the disability.

11. The system of claim 8, wherein:
the passenger profile data further comprises an indication that the passenger is an animal, and the determining whether the passenger belongs to the protected class is based on the indication.

12. The system claim 1, wherein:
the processor is implemented in a user device communicating with the vehicle,
the user device receives, from the user device, a start signal representing that the vehicle is turned on, and
the processor performs the operation in response to the start signal.

13. A computer-implemented method for notifying a user of an existence of a passenger remaining in a vehicle, the method comprising:
receiving passenger profile data and destination data of the passenger,
associating the passenger profile data with a seat position of the vehicle,
tracking a location of the vehicle,
in response to the vehicle stopping at a destination, generating a match signal whether or not the destination matches the destination data, and
in response to the match signal indicating a match, notifying the user whether or not the passenger has exited the seat position.

14. The method of claim 13, further comprising:
receiving second passenger profile data and second destination data of a second passenger, wherein the operation of generating the match signal further comprises generating the match signal whether or not the destination matches at least one of the destination data and the second destination data;
associating the second passenger profile data with the second seat position of the vehicle;
in response to the match signal indicating the match, notifying the user whether or not the vehicle is at a final destination; and
in response to determining that the vehicle is at the final destination, notifying the user whether or not all the passengers have exited all the seat positions.

15. The method of claim 14, further comprising:
in response to determining that the vehicle is not at the final destination:
selecting an exiting passenger from the passenger and the second passenger based on a location of the vehicle, the destination data, and the second destination data;
notifying the user whether or not the exiting passenger has exited at least one of the seat position and the second seat position.

16. The method of claim 13, wherein the receiving passenger profile data and destination data of the passenger and associating the passenger profile data with the seat position of the vehicle comprise:
displaying a seating chart of the vehicle to the user on a graphical user interface; and
associating the passenger profile data with the seat position of the vehicle based on an input for the seating chart.

17. The method of claim 13, further comprising:
determining that the user has not confirmed that the passenger has exited the seat position; and
alerting the user to confirm that the passenger has exited the seat position.

18. The method of claim 13, wherein:
the passenger profile data further comprises contact information of a remote device, and
the operations further comprise:
determining that the user does not confirm that the passenger has exited the seat position; and
alerting the remote device that the user has not confirmed that the passenger has exited the seat position.

19. The method of claim 13, further comprising:
determining that the user has confirmed that the passenger has exited the seat position; and
re-notifying the user whether or not the passenger has exited the seat position.

20. The method of claim 13, further comprising:
determining whether the passenger belongs to a protected class based on the passenger profile data,
wherein the notifying the user whether or not the passenger has exited the seat position is performed in response to determining that the passenger belongs to the protected class.
